(19) United States
(12) Patent Application Publication
(10) Pub. No.: US 2023/0185253 A1
(43) Pub. Date: Jun. 15, 2023

(54) GRAPH CONVOLUTIONAL REINFORCEMENT LEARNING WITH HETEROGENEOUS AGENT GROUPS

(71) Applicant: Siemens Corporation, Iselin, NJ (US)

(72) Inventors: Anton Kocheturov, Langhorne, PA (US); Dmitriy Fradkin, Wayne, PA (US); Nikolay Borodinov, Yardley, PA (US); Arquimedes Martinez Canedo, Plainsboro, NJ (US)

(21) Appl. No.: 17/997,590

(22) PCT Filed: Apr. 30, 2021
(86) PCT No.: PCT/US2021/030102

§ 371 Date: Oct. 31, 2022

Related U.S. Application Data
(60) Provisional application No. 63/020,040, filed on May 5, 2020.

(51) Int. Cl. G05B 13/02

(52) U.S. Cl. CPC G05B 13/027

(57) ABSTRACT

A system and method adaptively control a heterogeneous system of systems. A graph convolutional network (GCN) that receive a time series of graphs representing topology of an observed environment at a time moment and state of a system. Embedded features are generated having local information for each graph node. Embedded features are divided into embedded states grouped according to a defined grouping, such as node type. Each of several reinforcement learning algorithms are assigned to a unique group and include an adaptive control policy in which a control action is learned for a given embedded state. Reward information is received from the environment with a local reward related to performance specific to the unique group and a global reward related to performance of the whole graph responsive to the control action. Parameters of the GCN and adaptive control policy are updated using state information, control action information, and reward information.

### TECHNICAL FIELD

This application relates to adaptive control through dynamic graph models. More particularly, this application relates to a system that combines graph convolutional networks and reinforcement learning to analyze heterogeneous agent groups.

### BACKGROUND

Reinforcement Learning (RL) has been used for adaptive control in many applications. In RL, an agent interacts with an environment by observing it, selecting an action (from some discrete or continuous action set) and receiving occasional rewards. After multiple interactions, an agent learns a policy or a model for selecting actions that maximize its rewards, which must clearly be designed to encourage desired behavior in an agent.

Traditional approaches assume control over the whole system, which suffers from scalability issues and inflexibility that hinders quickly adapting to constantly changing conditions. The alternative solution is to utilize the concept of a system of systems, where an agent learns to control one or a group of similar subsystems and maximize rewards (e.g., KPIs) on both local (i.e., the subsystem group) and global (i.e., the entire system) levels, while taking into consideration information that is currently the most relevant to the agent.

A system of systems can be naturally described as a graph with nodes representing subsystems and edges between them (e.g., relationships between subsystems), which dictates how the nodes are connected and how the information is propagated between the nodes. To control a node, an agent can take information available directly at the node and all the nodes in its neighborhood. In this setup, each node is associated with a set of features (data) which may or may not be specific to the node type. Edges or links may be associated with their own set of features as well.

A type of machine learning models known as Graph Convolutional Networks (GCNs) can deal with learning from such complex graph-like systems. A GCN can apply a series of parameterized aggregations and non-linear transformations to each node/edge feature set respecting the topology of the graph and learning the parameters with a specific task in mind, like node classification, link prediction, feature extraction, etc.

Combined GCNs and RL frameworks have been demonstrated for different applications, including molecular graph generation, autonomous driving, traffic signal control, multi-agent cooperation (homogeneous robots), and combinatorial optimization. These approaches show a significant increase in performance. However, these approaches operate under an assumption that the graph nodes are homogeneous, i.e., they share the same action and observation spaces and, therefore, the RL agents share the same policy. Such a limitation fails to provide an accurate solution for modeling complex systems of heterogeneous agents.

### SUMMARY

A system and method adaptively control a heterogeneous system of systems. A graph convolutional network (GCN) receives a time series of graphs representing topology of an observed environment at a time moment and state of a system. Embedded features are generated having local information for each graph node. Embedded features are divided into embedded states grouped according to a defined grouping, such as node type. Each of several reinforcement learning algorithms are assigned to a unique group and include an adaptive control policy in which a control action is learned for a given embedded state. Reward information is received from the environment with a local reward related to performance specific to the unique group and a global reward related to performance of the whole graph responsive to the control action. Parameters of the GCN and adaptive control policy are updated using state information, control action information, and reward information.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows a block diagram of a computing environment for implementing the embodiments of this disclosure.

FIG. 2 shows an example of a framework combining a Graph Convolutional Network with Reinforcement Learning for modeling heterogeneous agent groups in accordance with embodiments of this disclosure.

### DETAILED DESCRIPTION

Methods and systems are disclosed for solving the technical problem of adaptive control of heterogeneous control groups. One challenge for training a reinforcement learning (RL) framework to control a dynamic collection of heterogeneous sub-system in communication with one another is that the graph nodes do not share the same action and observation spaces, and hence the RL agents do not share the same policy. To overcome the challenge of training the RL agents, the disclosed embodiments operate according to heterogeneous control policy grouping with a separate adaptive control policy per group. Graph convolutional networks operate for extraction of embedded features on the system level, while RL agents are trained to control groups on a subsystem level. As a result, RL agents perform adaptive control of complex heterogeneous systems. For example, cooperation of heterogeneous robots performing different tasks can be adaptively controlled through a framework of a graph convolutional network with specialized reinforcement learning.

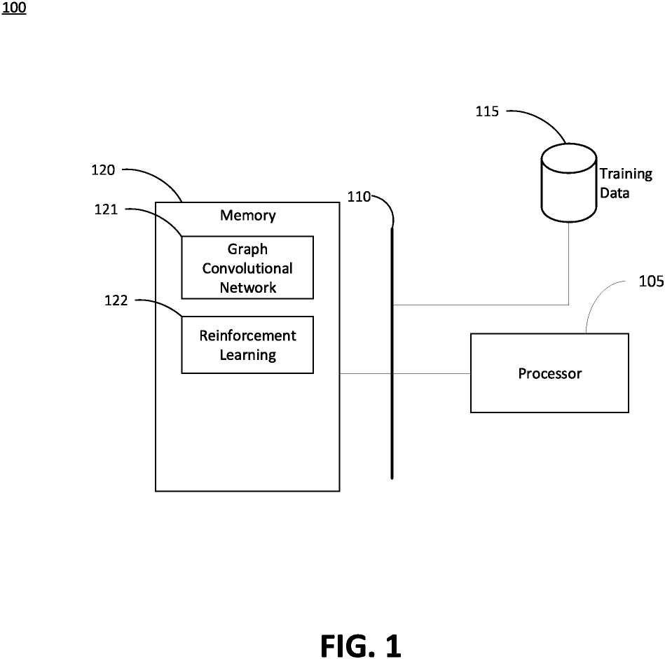

FIG. 1 shows a block diagram of a computing environment for implementing the embodiments of this disclosure. A computing system 100 includes a memory 120, a system bus 110, and a processor 105. A graph convolutional network module 121 is a neural network stored as a program module in memory 120. Reinforcement learning module 122 is stored as a program module in memory 120. Processor 105 executes the modules 121, 122 to perform the functionality of the disclosed embodiments. Training data 115 used to train the neural networks may be stored locally or may be stored remotely, such as in a cloud-based server. In an alternative embodiment, graph convolutional network module 121 and reinforcement learning module 122 may be deployed in a cloud-based server and accessed by computing system 100 using a network interface.

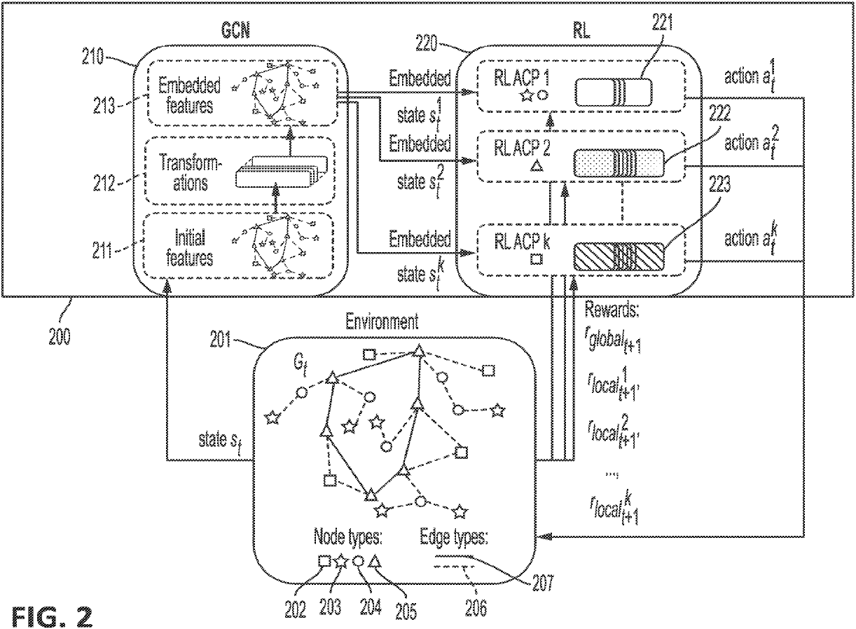

FIG. 2 shows an example of a framework combining a Graph Convolutional Network with Reinforcement Learning for modeling heterogeneous agent groups in accordance with embodiments of this disclosure. In an embodiment, an environment 201 represents a system of systems as a graph of nodes representing subsystems of different types and edges representing different types of subsystem relationships (e.g., how data is propagated between nodes). For example, environment 201 may include different node types 202, 203, 204, 205 and different edge types 206, 207. Feature sets of the environment 201 are observed at time moment t and constitute state sₜ of the system. The underlying graph Gₜ is naturally a part of sₜ as it depicts the topology at time moment t. While graph Gₜ as shown in FIG. 2, consists of a small number of nodes for illustrative purpose, an actual system graph may consist of tens of thousands of nodes. Therefore, training one control policy for the whole system is both computationally expensive and not adaptive.

Framework 200 includes GCN 210 and RL adaptive control policies 220. In an embodiment, graph nodes are divided into groups and are defined as having a separate control policy per group. Grouping of the graph nodes can be achieved in several ways, including but not limited to: node type, domain, topology, data cluster, and function. For example, a domain-driven grouping can be defined according to a strategy recommended by a domain expert. In a topology-driven grouping, hub nodes may fall into one group and the nodes on the periphery nodes may fall into another group. For data-driven grouping, nodes may be divided into groups according to their similarity with some clustering approach. As an example of function-driven grouping, a node’s function in the graph may change over time based on the node/edge to which it is connected. In an aspect, any of the various forms of grouping, such as the examples described above, (a) allows nodes of one type to be in different groups, (b) allows a group to contain nodes of different types, and (c) allows all nodes to be of the same type globally.

As shown in FIG. 2, initial features 211 compiled in state sₜ are fed to the GCN 210, which undergo a series of aggregations and non-linear transformations 212 (e.g., using the hidden layers, recurrent layers, or both, of the GCN) to extract embedded features 213 that contain local information for each node (features available directly at the node, its neighbors and edges adjacent to them). The layers are parameterized functions, which parameters are learned from the data simultaneously with the control policies. Alternatively, or additionally, the parameters are learned beforehand using, for example, machine learning approaches such as an autoencoder or a node feature prediction on graphs. Thus, the GCN 210 represents global knowledge of the whole system, which is shared across the RL adaptive control policies 220.

In an embodiment, the GCN 210 splits the embedded feature set 213 into embedded states

$${s}_{t}^{i}$$

according to the defined grouping (e.g., node type, domain, etc.), where i groups are defined. The example illustrated in FIG. 2 relates to grouping defined according to node type 202, 203, 204, 205, however, other grouping types may be defined. The embedded states

$${s}_{t}^{i}$$

are forwarded to RL adaptive control policies i, each of which is a separate instance of the same or different RL algorithm 221, 222, 223 and is learned to control a respective node group i (i.e., index i tracks both number of groups and RL policies). In an aspect, each embedded state

$${s}_{t}^{i}$$

is forwarded only to the corresponding RL adaptive control policy, according to a mapping. Alternatively, each RL adaptive control policy receives all embedded states

$${s}_{t}^{i} ,$$

but only acts upon the embedded state with the corresponding group or groups. As shown in the illustrated example in FIG. 2, RL adaptive control policy (ACP) 1 is defined for group 1 which is defined according to node types 203, 204, while RL ACP 2 corresponds to group 2 for node type 205 and RL ACP k corresponds to group k defined according to node type 1. For a given input embedded state

$${s}_{t}^{i} ,$$

RL adaptive control policy i outputs action

$${a}_{t}^{i}$$

and receives a reward

$${r}_{t}^{i}$$

from the environment, which may contain both local reward

$${r}_{l o c a l} {}_{{}_{t + 1}}^{i}$$

(specific to the node group) and global reward

$${r}_{g l o b a {l}_{t + 1}}$$

of the system. Thus, each RL adaptive control policy is used to control the specific node group accounting for the whole system’s performance at the same time. As such, the RL algorithms 221, 222, 223 are executed as RL agents. During the learning process, triplets

$$\left({s}_{t}^{i} , {a}_{t}^{i} , {r}_{t + 1}^{i}\right)$$

are used to update RL control policy parameters as in conventional RL, and further update corresponding parameters in the GCN layers, which then further tailors the sharable layers to the system control task at hand.

State of system sₜ incorporates both features of nodes and edges and the underlying graph Gₜ. Depending on the application and a particular instance of the system, the graph may be static (Gₜ₋₁ = Gₜ) as in power grid control, where the graph is assumed to be fixed for a particular power grid network, or dynamic (Gₜ₋₁ ≠ Gₜ) as in multi-agent cooperation setup, where the connections between nodes change dynamically as the nodes move in the environment. GCNs have a general adjustability to changing topology of the graph the via aggregation layers, which allow to account for varying neighborhood of a node (new/removed edges or nodes) and work with new nodes.

As an alternative to time-independent hidden GCN layers, the framework 200 may learn the temporal transitions in the network using a set of recurrent layers in the GCN block 210 configured to capture the dynamics of the graph as evolutions of nodes and edges at the feature level and generate embeddings with this information for use by the RL control policies at the control group policy level. In this case, the system takes a set of previous environment graphs (i.e., a time series of graphs) as input and generates the graph at the next time step as output, thus capturing in the embedded states highly non-linear interactions between nodes at each time step and across multiple time steps. As the embeddings capture the evolutions of nodes and edges, this information can be used by the RL group policies 220 to anticipate the adjustment of group control policies based on functional properties of the nodes and edges.

Advantages of the disclosed embodiments are summarized as follows. Sharable knowledge of the network across policies being is in the GCN layers. Specific control in Group Policies is generated by heterogeneous RL models. Scalability is increased by learning the Group Policies separately and backpropagating the RL policy information to the GCN layers. Adaptivity to changing conditions (changing topology, new/dropped nodes and links) is learned via aggregation and/or recurrent layers that analyze temporal transitions and thus capture varying network dynamics. Nodes are grouped by adaptive and/or fixed clustering based on similarity, domain knowledge or differences in action space. Furthermore, as the embeddings capture the node and edge temporal evolution, clustering can be done based on the functional properties of the nodes in the graph.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The block diagrams in the Figures illustrate the architecture, functionality, and operation of possible implementations of systems, methods, and computer program products according to various embodiments of the present disclosure. In this regard, each block in the block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams illustration, and combinations of blocks in the block diagrams illustration, can be implemented by special purpose hardware-based systems that perform the specified functions or acts or carry out combinations of special purpose hardware and computer instructions.

What is claimed is:

1. A system for adaptive control of a heterogeneous system of systems, comprising:
a memory having modules stored thereon; and
a processor for performing executable instructions in the modules stored on the memory, the modules comprising:
a graph convolutional network (GCN) comprising hidden layers, the GCN configured to:
receive a time series of graphs, each graph comprising nodes and edges representing topology of an observed environment at a time moment and state of a system,
extract initial features of each graph;
process the initial features to extract embedded features according to a series of aggregations and non-linear transformations performed in the hidden layers, wherein the embedded features comprise local information for each node;and
divide the embedded features into embedded states grouped according to a defined grouping;
a reinforcement learning module comprising a plurality of reinforcement learning algorithms, each algorithm being assigned to a unique group and having an adaptive control policy respectively linked to the unique group, each algorithm configured to:
learn a control action for a given embedded state according to the adaptive control policy;
receive reward information from the environment including a local reward related to performance specific to the unique group and a global reward related to performance of the whole graph responsive to the control action; and
update parameters of the adaptive control policy using state information, control action information, and reward information;
wherein the state information, the control action information and the reward information are also used to update parameters for the hidden layers of the GCN.

2. The system of claim 1,
wherein the GCN further comprises a plurality of recurrent layers configured to:
capture, in the embedded states, graph dynamics as evolutions of nodes and edges at the feature level, including non-linear interactions between nodes at each time step and across multiple time steps, using a set of previous graphs as input; and
wherein the reinforcement learning module is configured to use the embedded states to anticipate adjustment of group control policies based on functional properties of the nodes and edges.

3. The system of claim 1, wherein the graph is static.

4. The system of claim 1, wherein the graph is dynamic such that connections between nodes change dynamically as the nodes move in the environment.

5. The system of claim 1, wherein the grouping is defined according to node type.

6. The system of claim 1, wherein the grouping is defined according to domain.

7. The system of claim 1, wherein the grouping is defined according to graph topology.

8. The system of claim 1, wherein the defined grouping is data-driven.

9. The system of claim 1, wherein the defined grouping is function driven.

10. The system of claim 1, wherein the defined grouping allows nodes of one type to be in different groups.

11. The system of claim 1, wherein the defined grouping allows a group to contain nodes of different types.

12. The system of claim 1, wherein the defined grouping allows all nodes to be of the same type globally.

13. A method for adaptive control of a heterogeneous system of systems, comprising:
receiving, by a graph convolutional network (GCN), a time series of graphs, each graph comprising nodes and edges representing topology of an observed environment at a time moment and state of a system,
extracting, by the GCN, initial features of each graph;
processing, by the GCN, the initial features to extract embedded features according to a series of aggregations and non-linear transformations performed in the hidden layers, wherein the embedded features comprise local information for each node; and
dividing, by the GCN, the embedded features into embedded states grouped according to a defined grouping;
learning, by a reinforcement learning module algorithm, a control action for a given embedded state according to an adaptive control policy, wherein the algorithm is assigned to a unique group by the grouping policy and having an adaptive control policy respectively linked to the unique group;
receiving, by the reinforcement learning module algorithm, reward information from the environment including a local reward related to performance specific to the unique group and a global reward related to performance of the whole graph responsive to the control action; and
updating, by the reinforcement learning module algorithm, parameters of the adaptive control policy using state information, control action information, and reward information;
wherein the state information, the control action information and the reward information are also used to update parameters for the hidden layers of the GCN.

14. The method of claim 13, further comprising:
capturing, in the embedded states, graph dynamics as evolutions of nodes and edges at the feature level, including non-linear interactions between nodes at each time step and across multiple time steps, using a set of previous graphs as input; and
using, by reinforcement learning module algorithm, the embedded states to anticipate adjustment of group control policies based on functional properties of the nodes and edges.
